(19) United States
(12) Patent Application Publication
(10) Pub. No.: US 2011/0070556 A1
(43) Pub. Date: Mar. 24, 2011

(54) Micro evacuator and method of use

(75) Inventors: Hanna K. Haapasalo, Vancouver (CA); Gary J. Pond, Milwaukee, WI (US); John Baeten, Milwaukee, WI (US)

(73) Assignee: Inter-Med, Inc.

(21) Appl. No.: 12/799,651

(22) Filed: Apr. 29, 2010

Related U.S. Application Data
(60) Provisional application No. 61/214,838, filed on Apr. 29, 2009.

(51) Int. Cl. A61C 17/08; A61C 17/022

(52) U.S. Cl. 433/82; 433/92

(57) ABSTRACT

An evacuation and/or irrigation device for use in connection with a vacuum source and used in a relatively localized surgical area. The evacuation device has a main body connected to a dental tool and a hook-like evacuation needle connected to the body. The needle has a plurality of spaced apart vacuum ports to provide irrigation circumferentially to sterilize and clean the surgical area.

### RELATED APPLICATIONS

This application claims the benefit of U.S. Provisional Patent Application Ser. No. 61/214,838, filed 29 Apr. 2009.

### BACKGROUND OF THE INVENTION

The present invention relates to medical and dental equipment for use in irrigating and evacuating a surgical or dental site, and more particularly to evacuation devices for use in areas of limited space.

During evasive practices, such as during surgeries and some dental procedures, the ability to properly view the area being operated on is essential. This is usually done with irrigation or evacuation devices, where a liquid, such as water, and a suction device are used in combination to clean the area. In procedures of a larger scale, this is generally a relatively straightforward process. However, for procedures performed in smaller areas, irrigation and evacuation of the area of interest is a more arduous task, which may result in less than ideal treatment.

Endodontic treatment (root canal treatment of infected teeth) usually requires shaping, cleaning and disinfection of the root canal system inside the affected tooth to initiate healing of the destructed bone, which has been caused by a bacterial infection in the root canal. There are, however, a number of cases where conservative treatment of the root canal is not sufficient to bring about healing, and the infection persists. Reasons for such persistent infections are often either anatomical or microbiological or both. In any case, endodontic surgery is required to create favorable conditions for healing in such situations.

The goal of endodontic surgery is usually to cut and remove a few millimeters from the root tip (referred to as an apicoectomy), prepare a retrograde cavity at the apex using highly specialized instruments, and fill this “micro cavity” with a retrograde filling material such as mineral trioxide aggregate (MTA), intermediate restorative material (IRM) or zinc oxide (Super EBA) cements. One of the remaining challenges during an apicoectomy is that, in many cases, bleeding from the granulation tissue (soft tissue grown to the area of bone cavity during infection) or from the surrounding bone makes it difficult to keep the retrograde cavity clean and dry when placing the filling cement. Moisture and blood from the surrounding tissue would either destroy or weaken the favorable properties of the retrograde filling.

Various types of surgical suction tips are used to control the bleeding and keep the cavity or cavities dry during the filling. However, due to often limited visibility and the fact that the suction tips can only address the problem of bleeding at one site (i.e. where the tip is placed), bleeding from other areas can reach the cavity and cause continuous delays during the surgical procedure. A device that provided evacuation from many areas, such as a suction loop, could remove blood or other liquids from all sides of the root tip continuously.

### SUMMARY OF THE INVENTION

The present invention is an evacuation and irrigation device for use in medical areas, preferably confined dental areas, such as the jaw area below and around teeth and roots. The device generally comprises an adaptor section for connecting the device to a medical evacuation source. The adaptor section comprises a fluid pathway connecting a hook-like or arced evacuation needle to the evacuation source. The evacuation needle has a plurality of ports located on the needle, which allow for multi-directional or circumferential evacuation from the dental area.

The evacuation/irrigation device is also designed so that it may be arranged within a dental area to provide an essentially hands free operation. The shape and dimensions of the device allow positioning around the teeth and gums, wherein the device would be supported by the surrounding area.

The evacuation/irrigation device also has the benefit that it removes blood or other liquids in the area from all sides of the root tip, thus giving continuous, “all-around” protection against bleeding. By doing this, the device reduces the time required for invasive surgical operations, including dental operations, As an example, for a surgical apicoectomy, the device can assist in improving the quality of retrograde fillings, securing optimal conditions for their placement.

### BRIEF DESCRIPTION OF THE DRAWINGS

FIG. 1A is a perspective view of an evacuation and irrigation device developed according to the present invention.

FIG. 1B is a top planar view of the device of FIG. 1A.

FIG. 1C is a side elevation view of the device of FIG. 1A.

FIG. 2 is an exploded view of the evacuation and irrigation device of FIG. 1.

FIG. 3 is a perspective view of a person's teeth and gums that will be prepared for an apicoectomy procedure.

FIG. 4 is a perspective view of the teeth and gums of FIG. 3, with the gums being operated on with surgical cutting tools.

FIG. 5 is a perspective view of the teeth and gums of FIG. 4, demonstrating the area around the teeth and gums being filled with bodily fluids resulting from the surgical procedures shown and discussed in FIG. 4.

FIG. 6 is a perspective view of the teeth and gums of FIG. 3, with the evacuation and irrigation device of the present invention being inserted into the teeth and gums area and around the root tip.

FIG. 7 is a perspective view of the device shown in FIG. 6, with the device being used to irrigate the teeth and gums.

FIG. 8 is a perspective view of the evacuation and irrigation device of the present invention, demonstrating the ability of the device to be held in place hands-free.

FIG. 9 is a further perspective view of the evacuation and irrigation device, providing an alternative arrangement for holding the device in place hands-free.

FIG. 10 is a perspective view of the device of the present invention interacting with a single tooth, with the device having an alternate arrangement for holding the device in place.

FIG. 11 is a perspective view of an alternate use of an evacuation and irrigation device of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

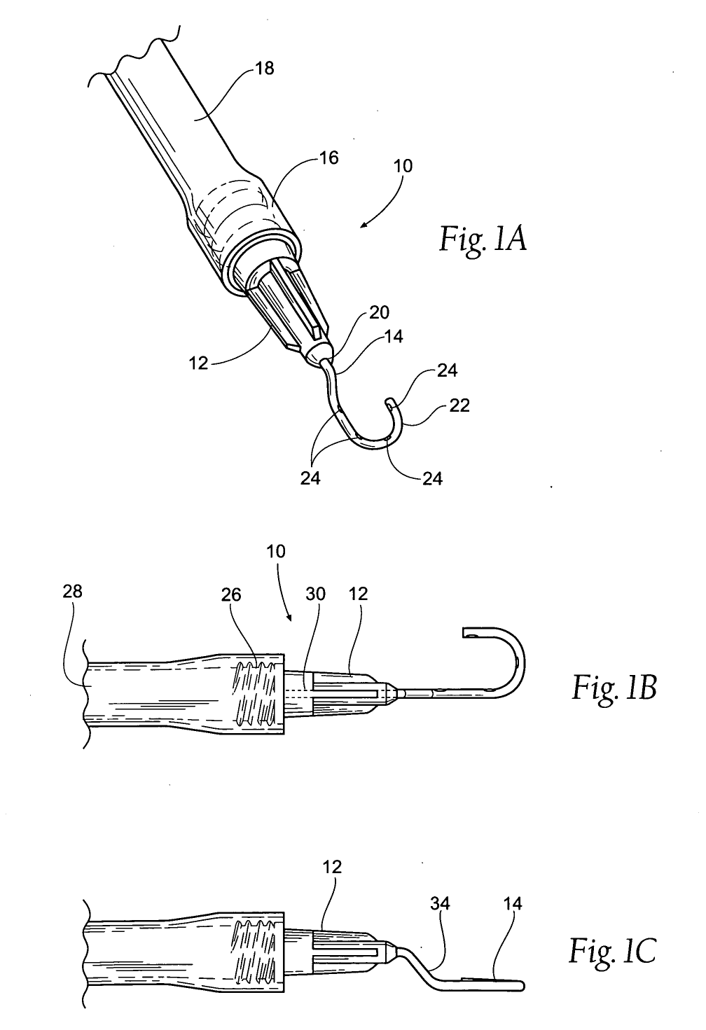

FIG. 1A provides a perspective view of an evacuation and irrigation device 10 according to the present invention. The device 10 can be used for irrigation, evacuation, and aspiration of a specific area, or a combination of the above for that area. The device 10 generally comprises a first portion 12 and a second portion 14. The first portion 12 comprises a supporting body, which has a first end 16, that allows the device 10 to be connected to a dental tool 18, and a second end 20 connecting the first portion 12 to the second portion 14. The second portion 14 generally comprises a dental tip 22 having a plurality of openings or vacuum ports 24 located on the dental needle or tip 22. The dental tip 22 generally has a hook-like structure. The dental tool 18 is preferably an evacuation device, such as a device connected to a vacuum source.

FIGS. 1B and 1C provide elevation views of the device 10. As previously stated, the first end 16 of the first portion 12 provides means for connecting the device 10 to the dental tool 18. Preferably, the first end 16 comprises a threaded section 26, which can be threaded onto the dental tool 18. The dental tool 18 has a pathway 28 that provides fluid to the device 10. The pathway 28 is in fluid communication with a througbore 30 located within the first portion 12, which is in fluid communication with a hollow passageway 32 located in the dental tip 22. Thus, fluid and other materials will be able to pass from the plurality of openings 24 located on the dental tip to the dental tool 18. The second portion 14 can be connected to the first portion 12 in any manner that will allow communication between the passageway 32 and the throughbore 30, such as by press-fitting the sections together or the use of adhesives.

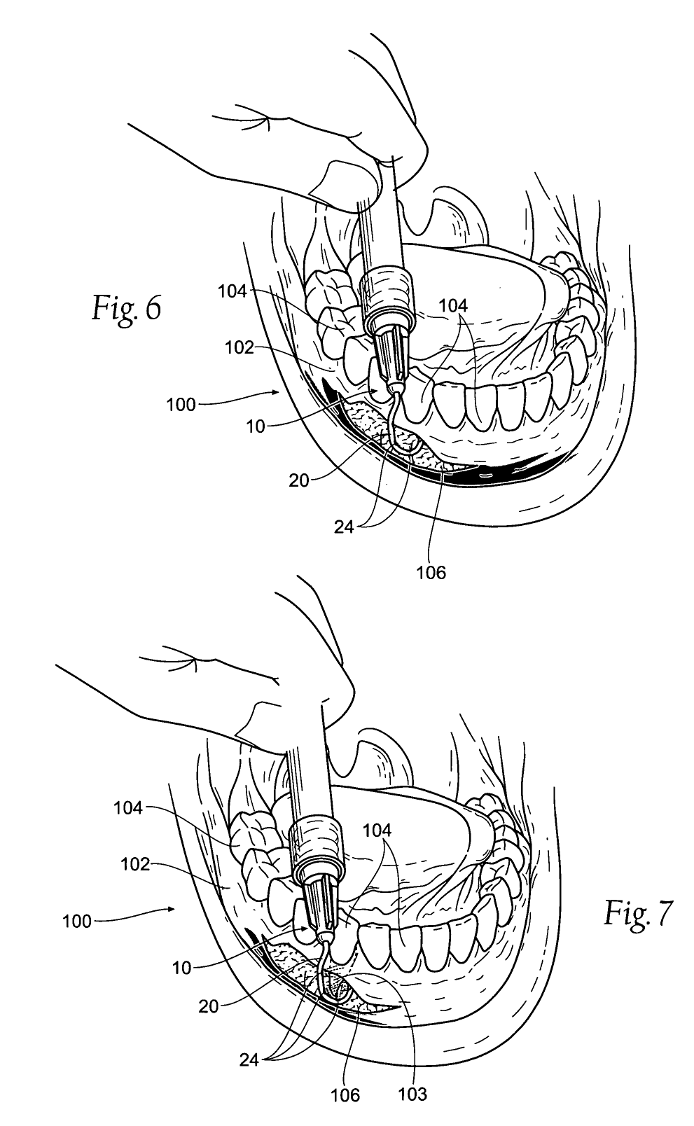

Referring further to FIGS. 1B and 1C, the dental tip 22 has a multi-directional design, which provides improved evacuation capabilities compared to prior designs. The openings 24 located on the dental tip 22 are spaced apart so that they will be directed inwardly towards the localized dental area, which will be discussed in more detail with respect to FIGS. 6 and 7. As previously stated, the second portion 14 comprises a dental tip 22 comprises a curved or hook-like structure. The dental tip 22 is connected to an angled section 34 that is connected to the first portion 12, which allows the dental portion 22 to be axially aligned within a plane that is distinct from the plane that the first portion 12 of the device 10 is located. As shown in FIG. 1C one preferable arrangement shows the first portion 12 and the dental tip 22 to be aligned in spaced apart planes that are substantially parallel with one another. As will be demonstrated further with respect to FIG. 7, this design of the dental tip 22 and the second portion 14 allows for the device 10 to be used and positioned without the user needing to necessarily hold the device 10.

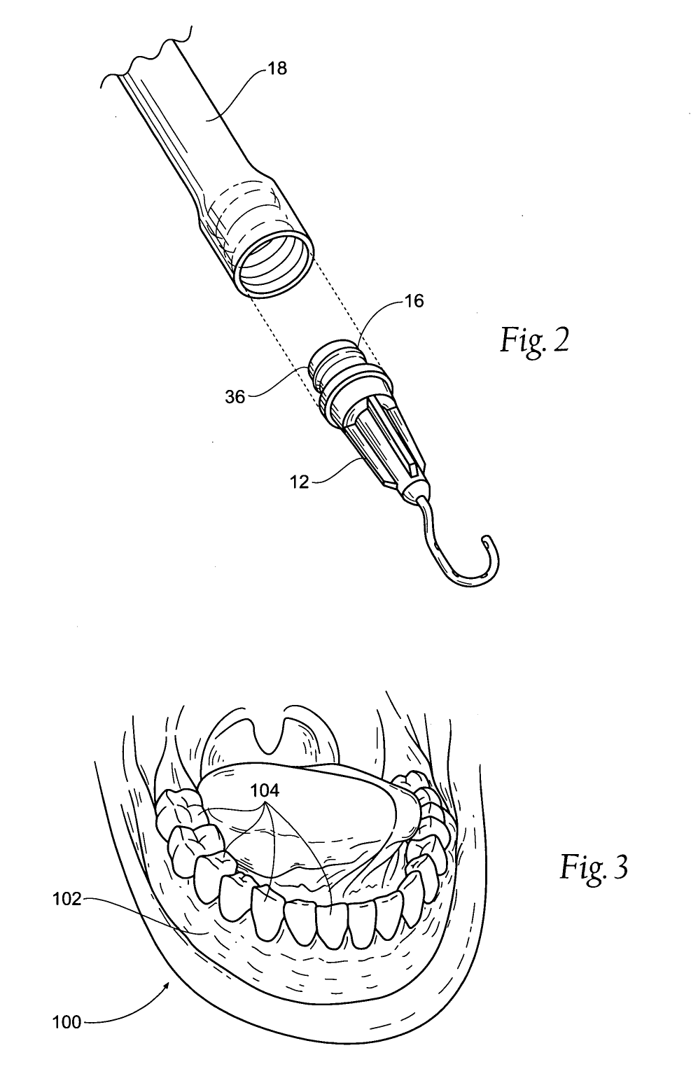

FIG. 2 provides a perspective view of the device 10 removed from the dental tool 18, which is preferably a vacuum source or a device capable of connecting to a vacuum source. The first end 16 of the first portion provides the connecting means for connecting the device 10 to the dental tool 18, which is shown as a threaded section 36 to mate with a threaded section 38 located on the dental tool 18. The threaded section 36 is shown as an externally threaded, but an internally threaded arrangement mating with an externally threaded arrangement on the dental tool 18 is also contemplate. Further, other arrangements for mating the device 10 with the dental tool 18 could be employed, as well. Provided that the connecting means allows communication between the dental tool 18 and the device 10, the connecting means would fall within the scope of the present invention.

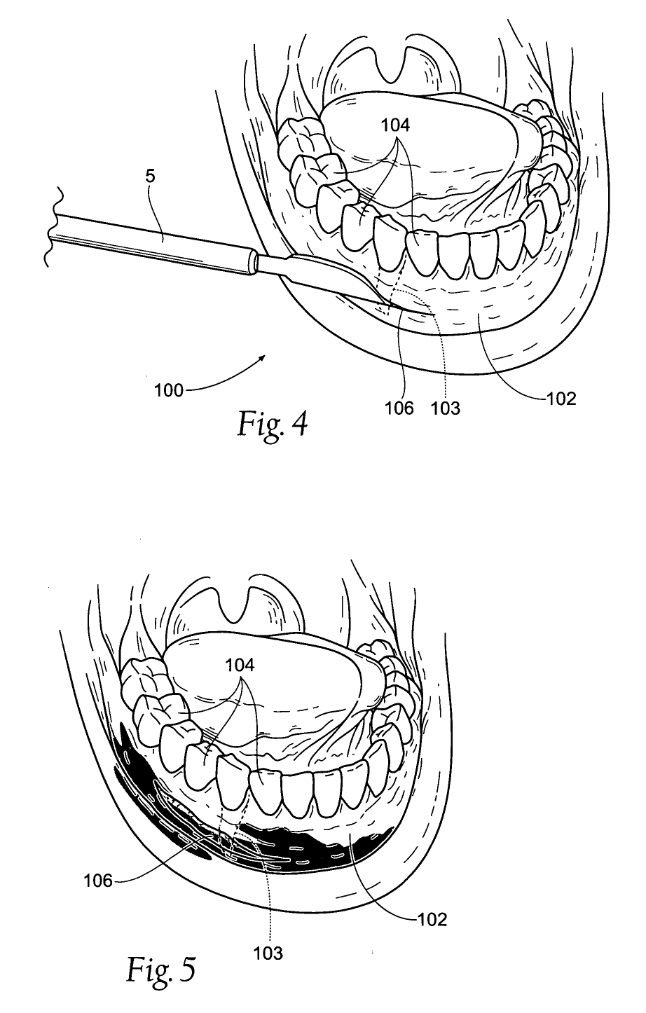

FIG. 3 provides a perspective view of a mouth 100 prior to having a surgical procedure performed within the mouth 100, such as an apicoectomy or a procedure to remove a lesion from the mouth 100. The mouth 100 has gums 102 supporting a plurality of teeth 104. As shown in FIG. 4, a scalpel 5 is inserted into the flesh of the gums 102 to from an incision 106. The incision 106 allows access to the internal area of the gums 102, such as below or around the root tip 103 of a tooth 104 to remove potential necrotic or infected material within the gums 102, root 103, tooth 104, or the surrounding jaw area.

As FIG. 5 demonstrates, once the incision 106 is made, the area around the incision 106 can quickly fill with blood, which may make it difficult to view the area around the incision 106. This can inhibit proper removal of unwanted material and, also, inhibit the refilling of the area with a cement or sealing material.

Removal of the excess blood can be accomplished by using the device 10, as shown in FIG. 6. The device 10 is inserted into the mouth 100, with the first portion 12 being positioned proximally to the incision 106, with the device 10 being spatially orientated upwardly with respect to the mouth 100. The dental tip 22 is situated generally within the incision 106, with the angle section 34 being positioned around a tooth 104 so that the first portion 12 is loosely fitted or positioned near the general contour of where the tooth 104 meets the gums 102. The dental tip 22 is preferably positioned around the end of the root tip 103 where the material needing removal is located.

FIG. 7 shows the device 10 being used to remove fluids and excess material from the area around the incision. Because of the shape of the dental tip 22 and the positioning of the device 10 around the tooth/incision area, the device 10 is capable of evacuating the area in a multi-directional fashion, with each of the openings 24 being directed inwardly toward the localized area being operated upon, thereby more efficiently removing fluid and debris from the area. The multi-directional functionality of the dental tip 22 allows more consistent and precise removal of fluids and material during procedures.

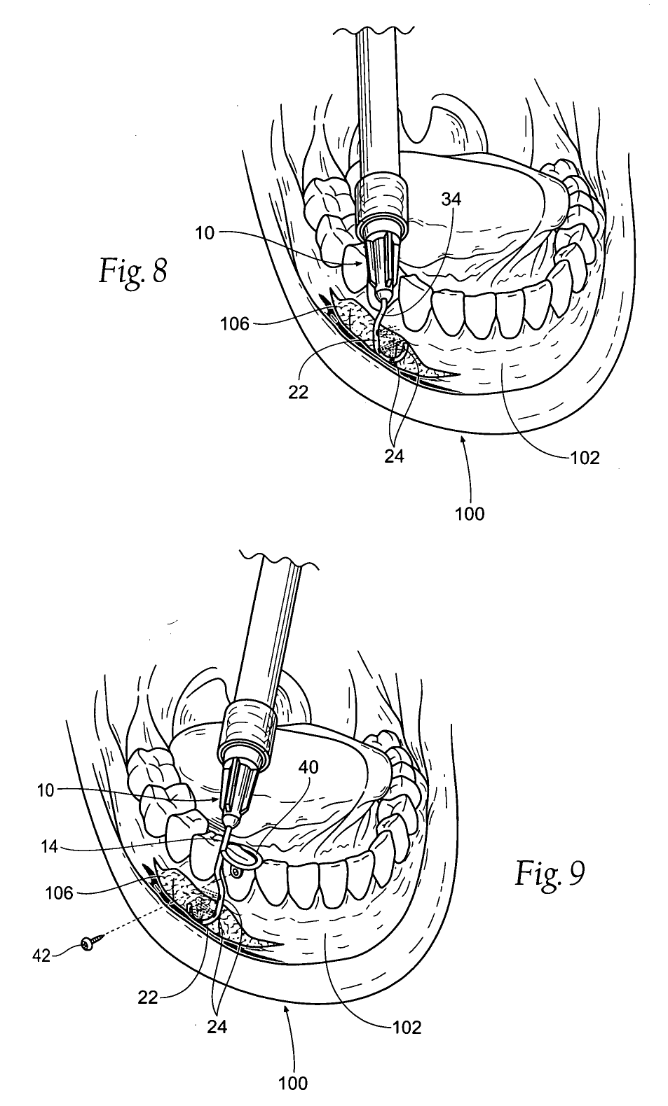

FIG. 8 demonstrates a further advantage of the device 10. The shape of the dental tip 22 allows the device 10 to be situated around a tooth 104, with the angled section 34 being positioned where the gums 102 and the exterior of the tooth 104 meet. The arrangement allows the ability of the device 10 to be held in position without a person having to hold the device 10 in that position, while still maintaining evacuation directed towards a specific, localized area.

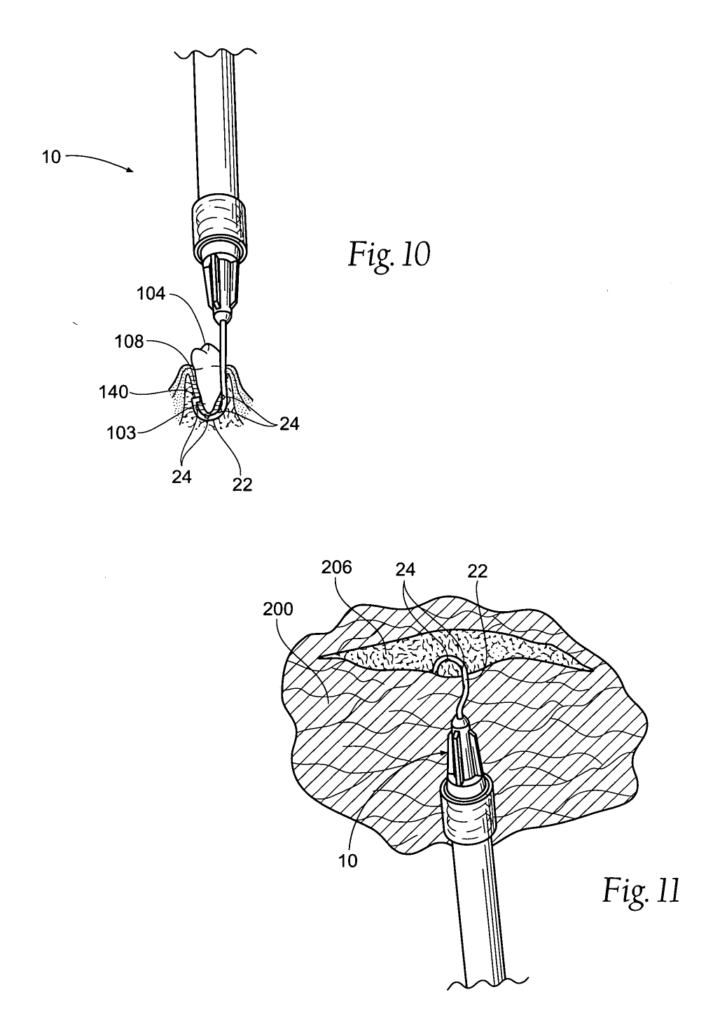

The device 10 can be fit around the individual tooth 104, either by fitting the dental tip 22 into the area around the tooth 104, or by using another structure to hold the device 10 in place 10. For example, FIG. 9 shows the device 10 being held in place with the use of a ring 40, which will be shaped to be positioned around the tooth 104. Alternatively, fasteners, such as screws 42 may be used to hold the device 10 in place by fastening the device to the tooth 104 or the surrounding jaw. The screws 42 may be used alone or in combination with the ring 40 as is necessary. Provided that a device allows for mounting or positioning of the device so that it will be held in place essentially “hands-free”, the device should be considered as falling within the scope of the present invention. For example, the second portion 14 of the device 10 may be angled in a more perpendicular fashion, thereby forming a step that would sit on the area where the gums 102 and the exterior of the tooth 104 meet. Likewise, the device 10 could be designed with a horizontal extension member that could be used to anchor the device 10 in place.

As an example, of an alternate arrangement to anchor the device in place, FIG. 10 shows the dental tip 22 ending in anchoring member 140, which can be inserted into the bone and ligament material of the jaw surrounding the root 103 of the tooth 104. The anchoring member 140 could potentially be tacked within the periodontal ligament tissue 108, sufficiently enough to hold the device 10 in place.

The ability for the device 10 to provide multi-directional evacuation or irrigation for a localized area has benefits in other surgical procedures, as well, including dental and medical procedures. The multi-directional capability of the device 10 is an advantage in a wide range of procedures. For example, FIG. 11 shows the use of the device 10 on another area 200 of a body with an incision 206 formed on the area 200. Possible examples of such surgical procedures would include a laparoscopic procedure or in cosmetic surgeries, such as rhinoplasty. Such a procedure does not provide much room for a person to navigate and potentially limited viewing of the actual area that is being operated upon. Many times actual viewing is done indirectly with the use of an inserted endoscope, which inhibits manipulation of tools around the area, since it is not always easy to pinpoint and localize the operation area. The device 10 of the present invention assists in such situations by providing an evacuation arrangement that can be directed specifically towards the precise area being operated upon. The openings 24 will be able to remove fluid and materials in a multi-directional fashion, while the hook-like structure of the tip 22 can be used as a slight barrier between the operating area and the surrounding areas, thereby further limiting the amount of excess fluid that will get in to the operating area. Similarly, with the openings 24 facing inwardly toward the localized area, the amount of fluids that will be pulled in from the surrounding area will be minimized compared to previous evacuation devices. As used in FIG. 10, it may be desirous that the device is held in place with an adhesive so that it can be used as a hands-free device.

The ability to apply multi-directional irrigation according to the present invention can also be used for a larger localized surgical area, if necessary. For example, if the ports 24 on the tip 22 were designed on the outside of the tip 22, the device 10 could provide irrigation that would be directed outwardly from the tip 22 if the ports 24 were located on the outside of the tip 22. This would be advantageous in irrigating a larger localized surgical area, if desired.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/we claim:

1. An evacuation and/or irrigation device for use in connection with a vacuum source, said evacuation device being used in a relatively localized dental area, said device comprising:
means for connecting said device to said vacuum source;
a supporting body having a througbore; and
a hook-like evacuation needle connected to said supporting body, said needle having a hollow passageway in fluid connection with said througbore, said needle having a plurality of spaced apart vacuum ports.

2. The device according to claim 1, wherein said vacuum ports are directed inwardly towards said dental area.

3. The device according to claim 1, wherein said vacuum ports are directed outwardly from needle.

4. The device according to claim 1 wherein said irrigation needle further comprises:
a first portion laterally extending from said connecting mean; and
a second portion angularly extending from said first portion.

5. The device according to claim 4 wherein said second portion of said irrigation needle and said supporting body are in spaced-apart, substantially parallel planes.

6. The device according to claim 1 further comprising means for anchoring said device to said dental area.

7. An evacuation and/or irrigation device for use in connection with a vacuum source during a surgical procedure in a relatively localized area, said device comprising:
means for connecting said device to said vacuum source;
a supporting body having a throughbore; and
an arced needle connected to said supporting body, said needle having a hollow passageway in fluid connection with said through bore, said needle having a plurality of spaced apart vacuum ports.

8. The device according to claim 7, wherein said vacuum ports are directed inwardly towards said surgical area.

9. The device according to claim 7, wherein said vacuum ports are directed outwardly towards said surgical area.

10. The device according to claim 7, wherein said arced needle comprises a hook-like shape.

11. The device according to claim 7, wherein said arced needle comprises a circular shape.

12. The device according to claim 7 further comprising means to secure said device to said localized area.
